(19) United States
(12) Patent Application Publication
(10) Pub. No.: US 2026/0366359 A1
(43) Pub. Date: Nov. 19, 2026

(54) Double-Layered Glass Manufacturing Method And Double-Layered Glass Window System Manufactured Thereby

(71) Applicant: HIPER G&W CO., LTD., Seoul (KR)

(72) Inventors: Won Keun PARK, Seoul (KR); Boo Don JOO, Seoul (KR)

(21) Appl. No.: 19/133,814

(22) PCT Filed: Jul. 21, 2023
(86) PCT No.: PCT/KR2023/010590

§ 371 Date: May 29, 2025

(30) Foreign Application Priority Data
Dec. 1, 2022 (KR) 10-2022-0165767
Feb. 15, 2023 (KR) 10-2023-0019972
May 18, 2023 (KR) 10-2023-0064181

(51) Int. Cl. E06B 3/663; E06B 3/67; E06B 3/673

(52) U.S. Cl. CPC E06B 3/66342; E06B 3/6715; E06B 3/6733

(57) ABSTRACT

A double-layered glass disposed between a pair of glasses, including a first glass and a second glass, and having an expandable laminated structure with the first glass and the second glass, and facilitating insulation and UV protection, comprising: a functional film part forming a thickness relatively smaller than that of the glasses, and having an insulating coating layer and an ultraviolet protection coating layer; a support frame part disposed at an edge of the functional film part, and having one side of which is in contact with the second glass and the other side of which has a structure into which the functional film part is folded and inserted; and a joining frame part having a structure capable of being snap-coupled to the support frame part with the functional film part, and having one side of which is in contact with the first glass; wherein the support frame part and the joining frame part are formed into a structure in which the joined portions can be fitted together to prevent snap-coupled portion of the functional film part from being disjoined from the support frame part and the joining frame part.

### TECHNICAL FIELD

The present invention relates to a method for manufacturing double-layered glass and a double-layered window system thereby, the double-layered window system is light in weight due to the replacement of multiple glass layers and contains double layers of glass for easy insulation and UV protection.

### BACKGROUND ART

In response to harsh external conditions such as heat and cold, buildings need to be heated and cooled to meet the requirements for comfortable human living and activities, consuming large amounts of energy and emitting carbon dioxide in the process. However, limited energy resources are being depleted, and changes in the global environment caused by the heating and cooling of buildings and the increase in carbon dioxide emissions from industry and transportation are creating a situation that threatens human existence with catastrophic climate change. Under the common recognition that humanity could be destroyed if we continue as we are, the world is making great efforts to build consensus and take action to conserve energy and preserve the global environment.

Increasing the energy efficiency of buildings, which account for a large portion of energy consumption, is a major challenge in order to conserve energy and reduce carbon emissions, and various technologies and methods are being applied to increase the energy efficiency of buildings, such as better insulation of the building envelope and the use of energy-efficient appliances. However, the window, which is an essential part of the building, remains the most vulnerable part of the building energy efficiency due to the delay in the development of new concept windows that are easy to maintain, affordable, and last the life of the building while maintaining the original function of the window. Fenestrations such as windows and glass chassis doors are often fitted with curtains, blinds, or verticals on one side of the window to block out sunlight or block the view. However, installing such curtains, blinds, or verticals on one side of the window is not only cumbersome, but depending on the architecture of the building, there may not be enough space to hang curtains or blinds on one side of the window, or it may be functionally inappropriate to install the curtains or blinds so that they are exposed on the exterior side of the window.

In response to these problems, functional windows have been introduced in the past, in which the glass panes of windows are made of double-layered glass and roll screens or blinds are embedded inside. However, these conventional windows have a complicated structure, resulting in bulkiness and thickening of the double-layer glass, as well as problems with smooth operation. In addition, the cost is high due to the complex structure, and there are problems such as frequent failures and inconvenient use.

In effect, double-layered is called as the number of glasses used increases, and since glass has an inherent weight, the weight increases with the number of glasses stacked on top of each other.

The increased weight increases the cost of the structure that supports the glass, and it can also cause accidents while moving it.

### DISCLOSURE

### Technical Problem

The present invention is designed to solve the problems of the prior art described above, and provides a double-layered glass that is light in weight and has the same heat storage efficiency and ultraviolet function as conventional double-layered glass.

And in the method of manufacturing such double-layered glass, it is intended to provide not only triple-layered glass but also quadruple-layered glass.

The tasks of the present invention are not limited to those mentioned above, and other tasks not mentioned will be apparent to those skilled in the art from the following description.

### Technical Solution

A double-layered glass disposed between a pair of glasses, including a first glass and a second glass, and having an expandable laminated structure with the first glass and the second glass, and facilitating insulation and UV protection, comprising: a functional film part forming a thickness relatively smaller than that of the glasses, and having an insulating coating layer and an ultraviolet protection coating layer; a support frame part disposed at an edge of the functional film part, and having one side of which is in contact with the second glass and the other side of which has a structure into which the functional film part is folded and inserted; and a joining frame part having a structure capable of being snap-coupled to the support frame part with the functional film part, and having one side of which is in contact with the first glass; wherein the support frame part and the joining frame part are formed into a structure in which the joined portions can be fitted together to prevent snap-coupled portion of the functional film part from being disjoined from the support frame part and the joining frame part.

In addition, the support frame part and the joining frame part comprise a support region in contact with the functional film part and a snap-coupled region extending from the support region and configured that a part protruding from the support frame part is inserted into the joining frame part when the functional film part is folded.

Further, the joining frame part comprises a first projection projecting toward the support frame part and a second projection formed adjacent to said first projection toward an outer side of the double-layered glass and projecting toward the support frame part.

Further, the second projection is formed relatively shorter than the first projection, and protruded toward the outer side of the double-layered glass.

Further, the second projection includes a first sloping surface protruded toward the outer side of the double-layered glass from an end portion adjacent to the support frame part and formed so as to be inclined toward the first glass, and a first parallel surface bent in the direction of the first projection on the first sloping surface and parallel to the support frame part.

Further, the support frame part comprises a third projection projecting between the first projection and the second projection in the snap-coupled region; and a fourth projection extending outwardly from the third projection and projecting toward the second projection parallel to the third projection, and the fourth projection formed that an end portion of fourth projection projects toward the first sloping surface of the second projection.

Further, the fourth projection includes a second sloping surface in contact with the first parallel surface, and a second parallel surface formed so as to be inclined toward the first protrusion on the second parallel surface.

In addition, the double-layered glass further comprises a fixed jig part supporting the side of the support frame part and the joining frame part to prevent wobbling when the support frame part and the joining frame part are joined in a state where the functional film part is secured to the support frame part.

Further, the fixed jig part comprises a first latch joined to the support frame part, and a second latch part joined to the joining frame part at a position spaced from the first latch, and the area between the first latch and the second latch is formed in a bended shape corresponding to the shape of the support frame part and the joining frame part.

And the functional film part is formed so that at least two are provided between the double-layered glass, and the joining frame part comprises: a first joining frame part; and a second joining frame part having the same shape as the first joining frame part and disposed symmetrically about an imaginary line parallel to the first glass on an upper surface of the first joining frame part such that the upper surface is in contact with the imaginary line; and wherein the second joining frame part is formed so as to be joined with a second support frame part.

Meanwhile, a method for manufacturing double-layered glass comprises: placing a fixed jig part on a floor; engaging a support frame part adjacent to the fixed jig part, wherein a part of the support frame part is inserted into the fixed jig part; mounting a functional film part to the top of the support frame part; positioning a joining frame part on top of the functional film part in a state insertable into the fixed jig part; pressing the joining frame part to insert the joining frame part into the support frame part with the functional film part therebetween; and bonding the support frame part and the joining frame part.

In addition, the bonding the support frame part and the joining frame part comprises: a process of disposing a second glass on a lower portion of the support frame part, and disposing a first glass on an upper portion of the joining frame part; a process of applying an adhesive to the first glass and the second glass to bond the first glass to the joining frame part and the second glass to the support frame part; and a process of bonding the first glass, the second glass the joining frame part, the support frame part by applying an adhesive from the side.

### Advantageous Effects

According to the invention, a film is provided between a pair of glasses in a double-layer glass to replace the glass, which has the effect of reducing the weight by 33% for three-layer glasses and 50% for four-layer glasses.

And it will be possible to provide double-layered glass, where the film is used so that the tension of the film is preserved.

The effects of the present invention are not limited to the aforementioned effect, and other effects, which are not mentioned above, will be apparent to a person having ordinary skill in the art from the description of the claims.

### DESCRIPTION OF DRAWINGS

FIG. 1 is a combined perspective view of a method of manufacturing double-layered according to the first and second embodiments of the present invention and a double-layered window system manufactured thereby, wherein the windows are fitted with double-layered;

FIG. 2 is a cross-sectional view of a method of manufacturing double-layered according to a first embodiment of the present invention, and of double-layered in a double-layered window system manufactured thereby;

FIG. 3 is a drawing to illustrate a method of manufacturing double-layered according to a first embodiment of the present invention and a fixture jig installed for manufacturing double-layered in a double-layered window system manufactured thereby;

FIG. 4 is a drawing to illustrate a method of manufacturing double-layered according to a first embodiment of the present invention and a detailed configuration of the double-layered in a double-layered window system manufactured thereby;

FIG. 5 is a cross-sectional view of a method for manufacturing double-layered glass according to a first modified embodiment of the present invention and a four-layered glass produced thereby;

FIG. 6 is a drawing to illustrate a method of manufacturing double-layer glass according to a first modified embodiment of the present invention, and the installation of a fixing jig in a double-layer glass manufactured thereby;

FIG. 7 is a drawing to illustrate a method of manufacturing double-layered glass according to a first modified embodiment of the present invention and a detailed configuration of a four-layered glass in a double-layered glass manufactured thereby;

FIG. 8 is a cross-sectional view of a method for manufacturing double-layered glass according to a second embodiment of the present invention and of a double-layered glass in a double-layered glass window system manufactured thereby;

FIG. 9 is a drawing to illustrate a method of manufacturing double-layered according to a second embodiment of the present invention and a fixture jig installed for manufacturing double-layered in a double-layered window system manufactured thereby;

FIG. 10 is a drawing to illustrate a method of manufacturing double-layered according to a second embodiment of the present invention and a detailed configuration of the double-layered in a double-layered window system manufactured thereby;

FIG. 11 is a cross-sectional view of a method for manufacturing double-layered glass according to a second modified embodiment of the present invention and a four-layered glass produced thereby;

FIG. 12 is a drawing to illustrate a method of manufacturing double-layer glass according to a second modified embodiment of the present invention, and the installation of a fixing jig in a double-layer glass manufactured thereby;

FIG. 13 is a drawing to illustrate a method of manufacturing double-layered glass according to a second modified embodiment of the present invention and a detailed configuration of a four-layered glass in a double-layered glass manufactured thereby;

FIG. 14 is a drawing illustrating a composite system window in a double-glazed window system manufactured by a method of manufacturing double-glazed glass in accordance with the first and second embodiments of the present invention;

FIG. 15 is a side view illustrating a composite system window in a double-glazed window system manufactured by a method of manufacturing double-glazed glass according to the first and second embodiments of the present invention;

FIG. 16 is a cross-sectional view of a composite system window in a double-glazed window system manufactured according to the first and second embodiments of the present invention and a method of manufacturing double-glazed windows thereby;

FIG. 17 is a cross-sectional view illustrating a method of manufacturing double-glazing according to the first and second embodiments of the present invention, and a finishing block mounting structure for a composite system window in a double-glazed window system manufactured thereby;

FIG. 18 is a flowchart illustrating a method of manufacturing double-layered in accordance with the first and second embodiments of the present invention, and a double-layered window system manufactured thereby;

FIG. 19 is a flowchart illustrating a method of manufacturing double-layered glass according to the first modified embodiment and the second modified embodiment of the present invention, and a method of manufacturing four layers of glass in a double-layered glass window system manufactured thereby.

### MODE FOR INVENTION

Hereinafter, preferred embodiments of the invention will be described with reference to the accompanying drawings, according to which the objects of the invention may be specifically realized. In describing the embodiments, the same designations and the same symbols are used for identical configurations, and further description will be omitted accordingly.

The invention will now be described in detail with reference to the drawings.

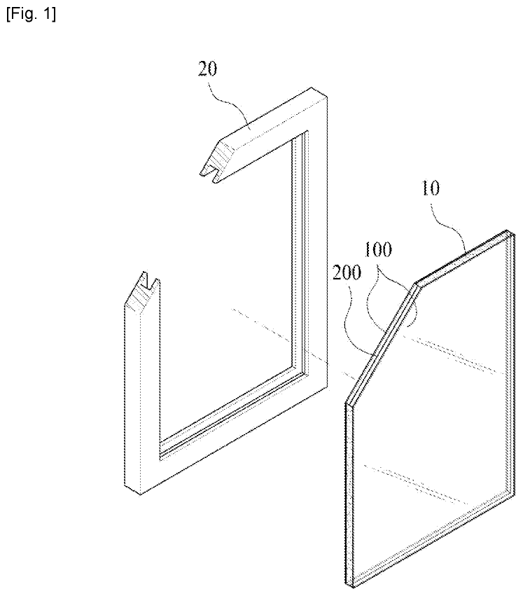

FIG. 1 is a diagram illustrating a method of manufacturing double-layered according to the first and second embodiments of the present invention, and a coupled perspective view of a window in a double-layered window system manufactured thereby, wherein the window is fitted with double-layered.

First, the present invention may broadly include a functional film portion 200, a support frame part 500, and a joining frame part 300.

The functional film portion 200 is formed with a thickness relatively smaller than the glass, and an insulating coating layer, an ultraviolet protection coating layer, and the like may be formed.

For example, the functional film portion 200 may be thinly coated with a metal or metal oxide, such as silver, so that the transmittance of visible light in the wavelengths of sunlight is similar to that of ordinary glass, but infrared light is reflected, thereby minimizing heat transfer, which can be effective for thermal management in a room.

This means that it reflects indoor heating heat back into the room, and in the summer months, it can block radiant heat from the sun from entering the room, increasing insulation.

As shown, the double-layered glass 10 according to one embodiment of the present invention is applicable to structures where glass is used, such as system windows 20 or windows, and is characterized in that a functional film portion 200 replaces the glass between a pair of panes of glass.

The double-layer glass 10 according to the present invention has a first glass 120 and a second glass 140 spaced apart from each other, and a functional film portion 200 is disposed between the first glass 120 and the second glass 140.

The first glass 120 will be referred to herein as the upper first glass 120 and the lower second glass 140, depending on where they are shown in the drawings.

Continuing, each of the first glass 120, the functional film portion 200, and the second glass 140 may have the same separation distance.

In a cross-sectional view of the double-layer glass 10 according to one embodiment of the present invention, a first glass 120 and a second glass 140 and a functional film portion 200 are arranged, and the functional film portion 200 is fixed with a support frame part 500 and a joining frame part 300.

Specifically, the support frame part 500 may be disposed on a first side of the functional film portion 200 and the joining frame part 300 may be disposed on a second side of the functional film portion 200 such that the support frame part 500 and the joining frame part 300 are coupled.

The support frame part 500 may be disposed along an edge of the functional frame part, one side of which is in contact with the glass, and the other side of which is inserted when the functional film portion 200 is folded as the joining frame part 300 is inserted, and may have a structure in which a portion of the joining frame part 300 is coupled.

The joining frame part 300 has a structure capable of being snap-coupled to the support frame part 500 together with the functional film portion 200, and may be configured to contact glass on one side.

With the functional film portion 200 coupled to the joining frame part 300 and the support frame part 500, the first glass 120 and the second glass 140 can be placed on the top and bottom, respectively, and the adhesive 800 applied to the edges to form the double-layer glass 10.

The double-layered glass 10 according to one embodiment of the present invention is secured by a support frame part 500 and a joining frame part 300 such that the tension of the functional film portion 200 is maintained, and the support frame part 500 and the joining frame part 300 securing the functional film portion 200 will be described with reference to two embodiments.

### First Embodiment

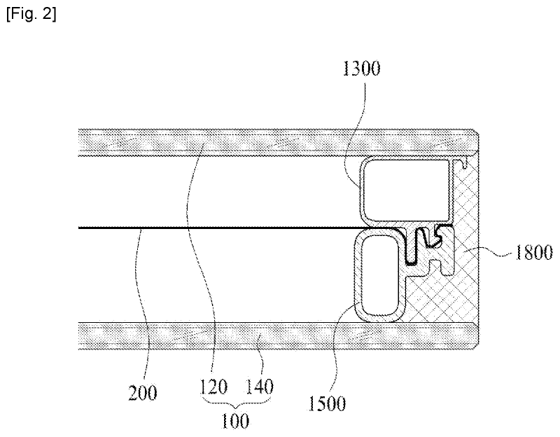

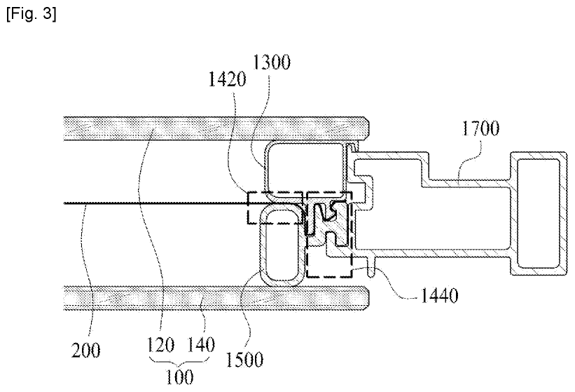

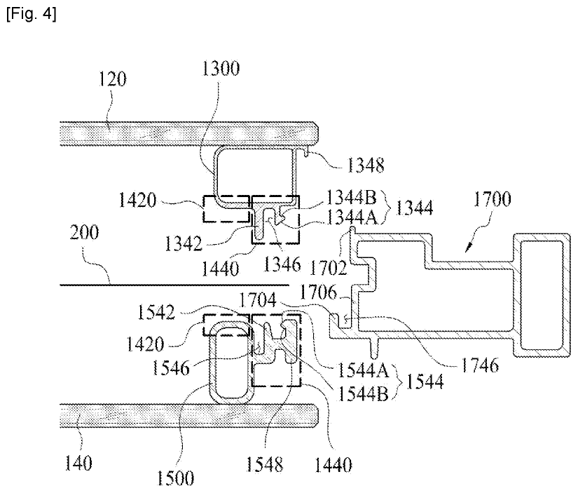

FIG. 2 is a cross-sectional view of double-layered in a double-layered window system manufactured in accordance with a method of manufacturing double-layered according to one embodiment of the present invention, FIG. 3 is a drawing to illustrate the installation of a fixing jig 700 to manufacture double-layered in a double-layered window system manufactured in accordance with a method of manufacturing double-layered according to a first embodiment of the present invention, and FIG. 4 is a drawing to illustrate a detailed configuration of double-layered in a double-layered window system manufactured in accordance with a method of manufacturing double-layered according to a first embodiment of the present invention.

In order to manufacture the double-layer glass 10 in the present invention, the support frame part 500 is first joined to the fixing jig portion 700, and the functional film portion 200 is disposed on top of the support frame part 500, and the joining frame part 300 is pressed to join the joining frame part 300 and the support flame portion.

At this time, the joining frame part 300 may be coupled together with the functional film portion 200 to the support frame part 500 with a certain pressure by a pressing device.

The structure of the support frame part 500 and the joining frame part 300 to which the functional film portion 200 can be fixedly coupled will now be described.

The support frame part 500 and the mating frame part 300 may include a support region 420 that abuts the functional film portion 200 and a fitment region 440 that extends from the support region 420 and is inserted into the mating frame part 300 as the functional film portion 200 is folded, with a portion protruding from the support frame part 500 being inserted into the mating frame part 300.

First, the joining frame part 300 may include a first projection 342 projecting from the engagement region 440 toward the support frame part 500 and a second projection 344 formed adjacent the outer side of the double-layered glass 10 at the first projection 342 and projecting toward the support frame part 500.

Here, the second projection 344 may be formed with a relatively shorter protruding length than the first projection 342, and may be formed with a predetermined projection toward the first projection 342 on a first side facing the first projection 342.

Referring specifically to FIG. 4, the joining frame part 300 may have a portion of its lower surface adjacent to the center of the double-layered glass 10 as a support region 420 and a portion extending from said portion toward the outer side of the double-layered glass 10 to form a fitment region 440.

And the second projection 344 may have a first inclined surface 344A formed to project toward an opposing side of the first projection 342 for engagement with the support frame part 500, and a first parallel surface 344B formed to be inclined and bent from the first inclined surface 344A toward a side of the second projection 344.

Meanwhile, the support frame part 500 may include a third projection 542 that projects between the first and second protrusions 342 and 344 in the engagement region 440.

First, the support frame part 500 may have an elliptical shape in a portion adjacent to the center of the double-layered glass 10, a third projection 542 extending from said portion toward the outer side of the double-layered glass 10 and inserted between the first projection 342 and the second projection 344, and a fourth projection 1544 extending from said third projection 542 toward the outer side of the double-layered glass 10, parallel to said third projection 542 and engaging said second projection 344.

The fourth projection 1544 may have a shape extending from the third projection 542 toward an outward side of the double-layered glass 10 and projecting toward the first glass 120 and the second glass 140, respectively.

Thus, the space between the third projection 542 and the fourth projection 1544 where the second projection 344 is inserted may form a fifth groove not shown), and the lower portion of the fifth groove may be a sixth groove. In the sixth groove, a second shackle 704 may be inserted, as will be described later.

In summary, the third projection 542 and the fourth projection 1544 may be elongated to allow engagement of the support frame part 500 and the joining frame part 300 so that they can be inserted between the first projection 342 and the second projection 344 and between the second projection 344 and the anchoring jig portion 700 even when the support frame part 500 and the joining frame part 300 are in contact at the support region 420.

And between the third projection 542 and the body of the support frame part 500, a second recess 546 may be formed into which the first projection 342 may be inserted.

The fourth projection 1544 may also be formed to abut the second projection 344, specifically, the fourth projection 1544 may have a second parallel surface 1544B that projects toward the second projection 344 and contacts the first parallel surface 344B, and a second inclined surface 1544A formed at a protruding end of the second parallel surface 1544B that slopes toward the second projection 344.

Thus, when the support frame part 500 and the joining frame part 300 are coupled, the first inclined surface 344A and the second inclined surface 1544A are slidably inserted, and in the inserted state, the first parallel surface 344B and the second inclined surface 1544A are pressed against each other, causing the first inclined surface 344A and the second inclined surface 1544A to be pressed against each other, thereby firmly joining the support frame part 500 and the joining frame part 300.

In this case, the fourth projection 1544 may be supported on one side by the fixed jig portion 700. Specifically, as described above, the fourth projection 1544 may be elastically deformed as it is squeezed against the second projection 344, such that only the second inclined surface 1544A and the second inclined surface 1544A are deformed, and the upwardly projecting shape parallel to the third projection 542 may be contacted by the support wall 1706 of the fixing jig 700. It may further include a second member 1548 that projects downwardly from the fourth projection 1544 and inserts into the third groove 1746 of the fixing jig 1700.

The support wall 1706 is configured to stabilize the support frame part 1500 at the anchoring jig portion 700 and to support the support frame part 1500 from rocking so that the position and angle of the support frame part 1500 are not deformed under the up and down forces applied when the mating frame part 1300 and the support frame part 1500 are coupled together up and down.

Meanwhile, to prevent the support frame part 500 and the joining frame part 300 from wobbling during the process of being coupled together, the securing jig portion 700 may include a first shackle 702 supporting the joining frame part 300 and a second shackle 704 supporting the support frame part 500.

Specifically, the anchoring jig portion 700 can laterally support the support frame part 500 and the joining frame part 300 to prevent rocking when the functional film portion 200 is resting on the support frame part 500 and the joining frame part 300 is coupled to the support frame part 500.

Accordingly, a portion of the fastening jig portion 700 may be supported on a floor surface and formed with a first shackle 702 coupled to a portion of the mating frame part 1300 on a side facing the mating frame part 300 and a second shackle 704 coupled to a portion of the support frame part 1500 on a side facing the support frame part 300 and positioned below the first shackle 702.

The first shackle 702 may have a shape that protrudes horizontally from the top end of the anchoring jig portion 700 toward the mating frame part 300, with a vertically bent end upward.

A first shackle 1702 of such a shape may include a first member 1348 of such a shape that protrudes from the joining frame part 1300 to the first shackle 702 and is vertically bent at its lower end to span the upper portion of the first shackle 1702, thereby preventing the joining frame part 1300 from rocking.

The second shackle 704 may also have the same geometry as the first shackle 702.

The second shackle 704 may have a horizontal projection from the anchoring jig portion 700 toward the support frame part 500, with a vertically bent end upward. And the second shackle 1704 may have a vertical bend at an end that protrudes from the lower face of the anchoring jig 1700 toward the support frame part 1500, with a vertical bend at an upper end.

The second shackle 1704 may be inserted into the sixth groove between the third projection 1542 and the fourth projection 1544 in the support frame part 500.

Thus, the support frame part 1500 can be secured without causing the support frame part 1500 to sway by inserting the second member 1548, which is the lower end of the fourth projection 1544, into the third groove formed between the second shackle 1704 and the support wall 1706, and the upper end of the fourth projection 1544 and the second member 1548 contacting the support wall 1706.

And the first shackle 702 and the second shackle 704 may be formed such that the second shackle 704 is relatively longer than the first shackle 702 in length protruding from the fixed jig portion 700.

This is because if the first shackle 702 and the second shackle 704 are formed in the same position in the vertical direction, as shown, to distribute the load acting when the joining frame part 300 is joined from top to bottom, the load may be concentrated vertically and cause the fixing jig portion 700 to tilt.

Continuing, the first clasp 702 may support a first member 348 having a lower vertically bent end protruding from the joining frame part 300 toward the outside of the double-layered glass 10, and the second clasp 704 may support a second member 548 having a higher vertically bent end protruding from the support frame part 500 toward the outside of the double-layered glass 10.

The double-layer glass 10 shown in FIGS. 1 to 4 was characterized in that a functional film portion 200 was disposed internally between the first glass 120 and the second glass 140.

However, in accordance with a first modified embodiment of the present invention, it is also possible for a plurality of functional film portions 200 to be disposed between the first glass 120 and the second glass 140.

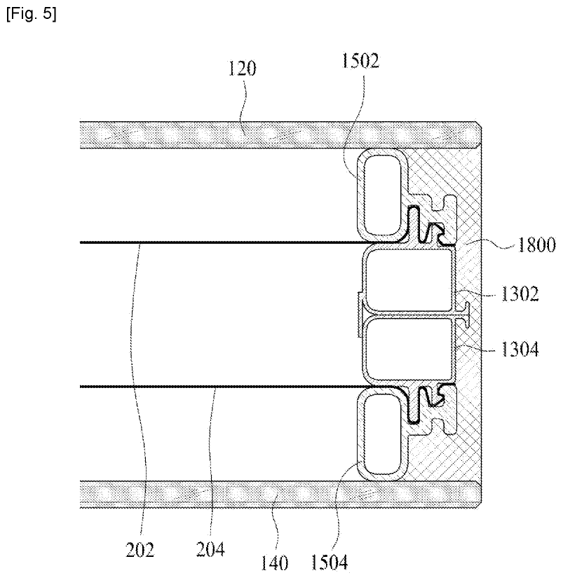

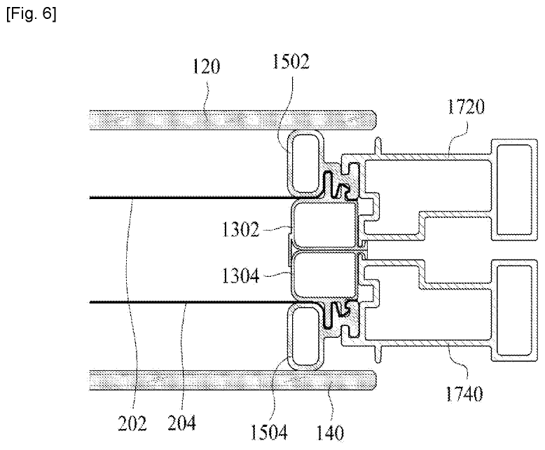

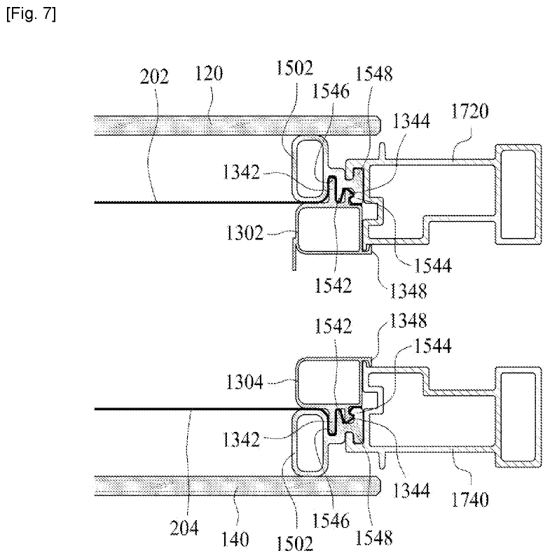

FIG. 5 is a cross-sectional view of a four-layer glass in accordance with the first modified embodiment of the present invention, FIG. 6 is a drawing to illustrate the installation of the fixing jig 700 in accordance with the first modified embodiment of the present invention, and FIG. 7 is a drawing to illustrate the detailed configuration of the four-layer glass in accordance with the first modified embodiment of the present invention.

The four-layer glass according to a modified embodiment of the present invention may have a combined shape by symmetrically shifting the three-layer glass around an imaginary horizontal line.

As shown, the quadruplex glass may be disposed between the first glass 120 and the second glass 140 in a top-to-bottom direction in the following order: first bonding frame part 302, first functional film portion 202, first support frame part 502, and second support frame part 504, second functional film portion 204, and second bonding frame part 304.

The first glass 120, the second glass 140, the first support frame part 502, the second support frame part 504, the first functional film, and the second functional film have the same shape as the double-layered glass 10 according to one embodiment of the present invention described above, so their structure will be omitted.

The four-layer glass according to a modified embodiment of the present invention may be formed such that the first joining frame part 302 and the second joining frame part 304 are couplable.

The first joining frame part 302 and the first support frame part 502 may be secured to the first anchoring jig portion 720, and the second joining frame part 304 and the second support frame part 504 may be secured to the second anchoring jig portion 740.

Thus, two pieces of double-layer glass 10 can be made and joined via first joining frame part 302 and second joining frame part 304, and adhesive 800 can be applied from the sides.

The first joining frame part 302 and the second frame part may be coupled to each other by being restrained or bonded to each other.

In this modified embodiment, resilient engagement means not shown may be formed on a lateral portion of the first joining frame part 302 to enable engagement with protrusions not shown on a lateral portion of the second joining frame part 304.

Alternatively, the first mating frame part 302 and the second mating frame part 304 may be bonded by applying adhesive 800 to the gap between them.

The structure of the protrusions 342, 344 and grooves 346 of the first joining frame part 302 and the second joining frame part 304 can also have a structure such that the first protrusion 342 of the first joining frame part 302 is inserted into the first groove 346 of the second joining frame part 304.

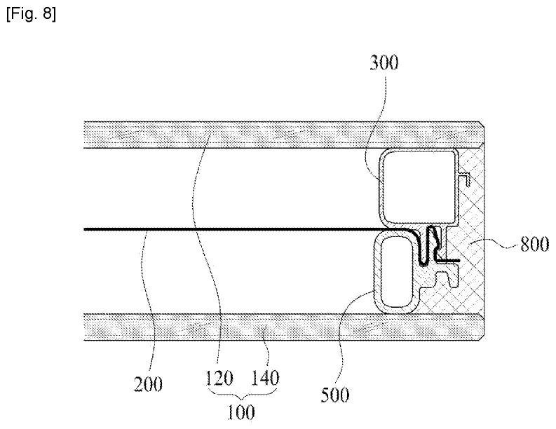

Referring now to FIGS. 8 through 10, a second embodiment of the present invention will be described.

### Second Embodiment

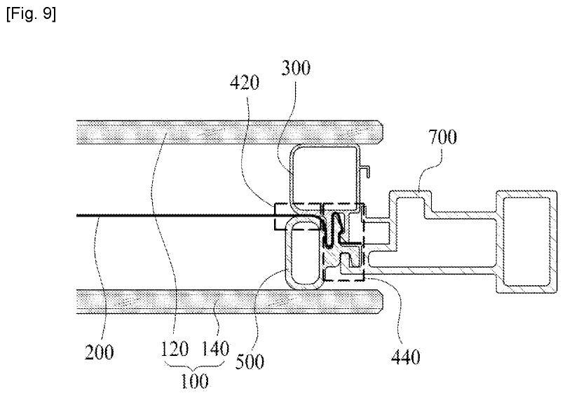

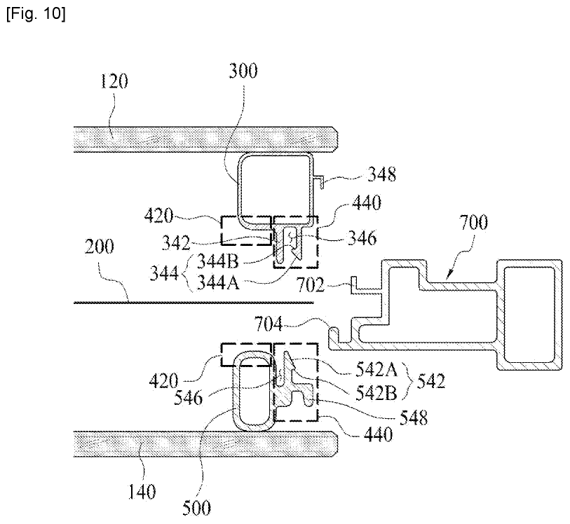

FIG. 8 is a cross-sectional view of the double-layered 10 in a double-layered manufacturing method according to a second embodiment of the present invention and a double-layered window system manufactured thereby, and FIG. 9 is a drawing to illustrate how the fixing jig 700 is installed to manufacture the double-layered 10 in a double-layered manufacturing method according to a second embodiment of the present invention and a double-layered window system manufactured thereby, FIG. 10 is a drawing for illustrating a method of manufacturing double-layered according to a second embodiment of the present invention and a detailed configuration of the double-layered 10 in a double-layered window system manufactured thereby.

In order to manufacture the double-layer glass 10 in the present invention, the support frame part 500 is first joined to the fixing jig portion 700, and the functional film portion 200 is disposed on top of the support frame part 500, and the joining frame part 300 is pressed to join the joining frame part 300 and the support flame portion.

At this time, the joining frame part 300 may be coupled together with the functional film portion 200 to the support frame part 500 with a certain pressure by a pressing device.

The structure of the support frame part 500 and the joining frame part 300 to which the functional film portion 200 can be fixedly coupled will now be described.

The support frame part 500 and the mating frame part 300 may include a support region 420 that abuts the functional film portion 200 and a fitment region 440 that extends from the support region 420 and is inserted into the mating frame part 300 as the functional film portion 200 is folded, with a portion protruding from the support frame part 500 being inserted into the mating frame part 300.

First, the joining frame part 300 may include a first projection 342 projecting from the engagement region 440 toward the support frame part 500 and a second projection 344 formed adjacent the outer side of the double-layered glass 10 at the first projection 342 and projecting toward the support frame part 500.

Here, the second projection 344 may be formed with a relatively shorter protruding length than the first projection 342, and may include a first snag member formed on a first side facing the first projection 342 with a predetermined projection toward the first projection 342.

Specifically, the joining frame part 300 may have a portion of its lower surface adjacent to the center of the double-layered glass 10 to form a support region 420 and a portion extending from said portion toward the outer side of the double-layered glass 10 to form a fitment region 440.

And the second projection 344 may have a first inclined surface 344A formed to project toward an opposing side of the first projection 342 for engagement with the support frame part 500, and a first parallel surface 344B formed to be inclined and bent from the first inclined surface 344A toward a side of the second projection 344.

Meanwhile, the support frame part 500 may include a third projection 542 that projects between the first and second protrusions 342 and 344 in the engagement region 440.

First, the support frame part 500 may have an elliptical shape in a portion adjacent to the center of the double-layer glass 10, and may have a third projection 542 extending from said portion toward the outside of the double-layer glass 10 and inserted between the first projection 342 and the second projection 344.

The third projection 542 may be formed long enough to be insertable between the first projection 342 and the second projection 344 even when the support frame part 500 and the joining frame part 300 are engaged, such that the support frame part 500 and the joining frame part 300 are in contact at the support region 420.

And between the third projection 542 and the body of the support frame part 500, a second recess 546 may be formed into which the first projection 342 may be inserted.

The third projection 542 may also have a second snagging member formed to engage the first snagging member, and the second snagging member may be formed to reverse the first snagging member in an up-down direction and a side-to-side direction.

Specifically, the second snagging member may be formed with a second parallel surface 544B that projects outwardly of the double-layered glass 10 and contacts the first parallel surface 344B, and a second inclined surface 542A formed at a protruding end of the second parallel surface 544B that is inclined toward the first projection 342.

Thus, when the support frame part 500 and the joining frame part 300 are engaged, the first inclined surface 344A and the second inclined surface 542A are inserted by sliding, and in the inserted state, the first parallel surface 344B and the second parallel surface 544B are engaged with each other, so that the support frame part 500 and the joining frame part 300 can be firmly coupled.

Meanwhile, to prevent the support frame part 500 and the joining frame part 300 from wobbling during the process of being coupled together, the securing jig portion 700 may include a first shackle 702 supporting the joining frame part 300 and a second shackle 704 supporting the support frame part 500.

Specifically, the anchoring jig portion 700 can laterally support the support frame part 500 and the mating frame part 300 to prevent wobbling when the functional film portion 200 is resting on the support frame part 500 and the mating frame part 300 is engaged with the support frame part 500.

Accordingly, a portion of the fixing jig portion 700 may be supported on a bottom surface and may have a first shackle 702 and a second shackle 704 formed on one side facing the mating frame part 300 and the support frame part 500.

The first shackle 702 may have a horizontal projection from the anchoring jig portion 700 toward the mating frame part 300 and a vertical bend at the end.

The second shackle 704 may also have the same geometry as the first shackle 702.

The second shackle 704 may have a horizontal projection from the anchoring jig portion 700 toward the support frame part 500 and a vertical bend upward at the end.

And the first shackle 702 and the second shackle 704 may be formed such that the second shackle 704 is relatively longer than the first shackle 702 in length protruding from the fixed jig portion 700.

This is because if the first shackle 702 and the second shackle 704 are formed in the same position in the vertical direction, as shown, to distribute the load acting when the joining frame part 300 is joined from top to bottom, the load may be concentrated vertically and cause the fixing jig portion 700 to tilt.

Continuing, the first clasp 702 may support a first member 348 having a lower vertically bent end protruding from the joining frame part 300 toward the outside of the double-layered glass 10, and the second clasp 704 may support a second member 548 having a higher vertically bent end protruding from the support frame part 500 toward the outside of the double-layered glass 10.

The quadruple-layered glass 10 will also be described below, along with the triple-layered glass 10 with the functional film portion 200 disposed between the first glass 120 and the second glass 140 and the first glass 120 and the second glass 140 as described above.

The quadruplex glass 10 will hereinafter be described as a quadruplex glass, which may have two functional film portions 200 laminated between the first glass 120 and the second glass 140.

Let's illustrate this with a drawing.

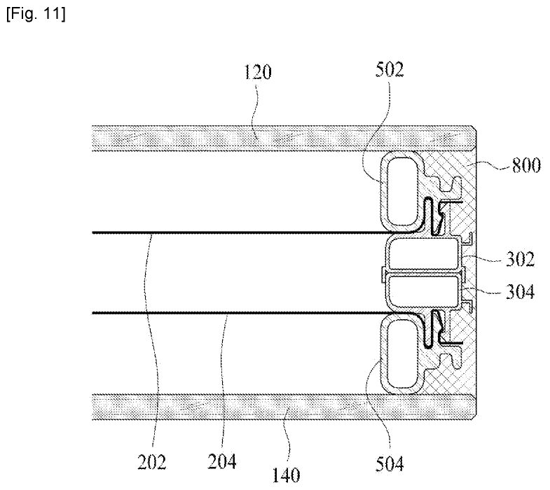

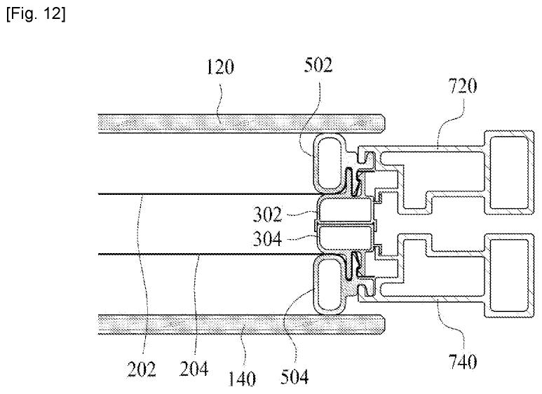

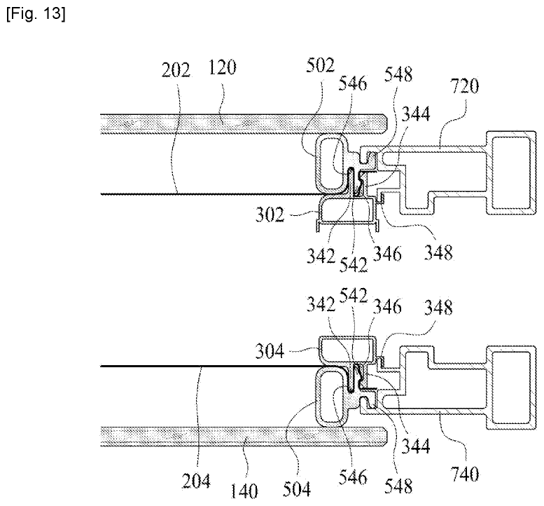

FIG. 11 is a cross-sectional view of a four-layer glass in a double-glazed glass manufacturing method according to the second modified embodiment of the present invention, FIG. 12 is a drawing to illustrate the installation of a fixing jig in a double-glazed glass manufacturing method according to the second modified embodiment of the present invention, and FIG. 13 is a drawing to illustrate the detailed configuration of a four-layer glass in a double-glazed glass manufacturing method according to the second modified embodiment of the present invention.

The four-layer glass according to a second modified embodiment of the present invention may have a combined shape by symmetrically shifting the three-layer glass 10 around an imaginary horizontal line.

As shown, the quadruplex glass may be disposed between the first glass 120 and the second glass 140 in a top-to-bottom direction in the following order: first bonding frame part 302, first functional film portion 202, first support frame part 502, and second support frame part 504, second functional film portion 204, and second bonding frame part 304.

The first glass 120, the second glass 140, the first support frame part 502, the second support frame part 504, the first functional film, and the second functional film have the same shape as the double-layered glass 10 according to one embodiment of the present invention described above, so their structure will be omitted.

The four-layer glass according to a modified embodiment of the present invention may be formed such that the first joining frame part 302 and the second joining frame part 304 are couplable.

Specifically, at least two functional film portions 200 are formed between the double-layered glass 10, The joining frame part 1300 may further include a first joining frame part 1302 and a second joining frame part 1304 having the same geometry as the first joining frame part 1302 and symmetrically disposed on an upper surface of the first joining frame part 1302 about an imaginary line not shown parallel to the first glass 120 such that the same side of said upper surface is in contact with said imaginary line, and a second support frame part 1504 coupled to the second joining frame part 1304.

The first joining frame part 302 and the first support frame part 502 may be secured to the first anchoring jig portion 720, and the second joining frame part 304 and the second support frame part 504 may be secured to the second anchoring jig portion 740.

Thus, two pieces of double-layer glass 10 can be made and joined via first joining frame part 302 and second joining frame part 304, and adhesive 800 can be applied from the sides.

The first joining frame part 302 and the second frame part may be coupled to each other by being restrained or bonded to each other.

In this modified embodiment, resilient engagement means not shown may be formed on a lateral portion of the first joining frame part 302 to enable engagement with the second projection 1344 of the lateral portion of the second joining frame part 304.

Alternatively, the first mating frame part 302 and the second mating frame part 304 may be bonded by applying adhesive 800 to the gap between them.

The structure of the protrusions 1342, 1344 and first groove 346 of the first joining frame part 302 and the second joining frame part 304 can also have a structure such that the first protrusion 342 of the first joining frame part 302 inserts into the first groove 346 of the second joining frame part 304.

In addition to the structure described above, various forms can be implemented for the structure in which the first joining frame part 302 and the second joining frame part 304 are coupled.

The structure of the double-layered glass 10 has been described above, and the double-layered glass 10 can be applied to a window system such as a sliding window or a curtain wall, and can be described as a double-layered glass 10 including the components of the composite glass 10 described above, the glass 100, the functional film part 200, the bonding frame part 1300, the support frame part 1500, and the fixing jig part 1700, and the double-layered glass 10 can be applied to a system window, a composite window, or a sliding window or a curtain wall.

In the following, a method for manufacturing the double-layered glass 10 of the present invention will be described.

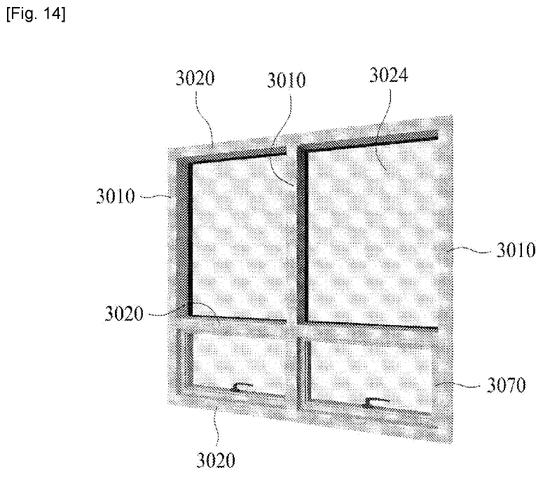

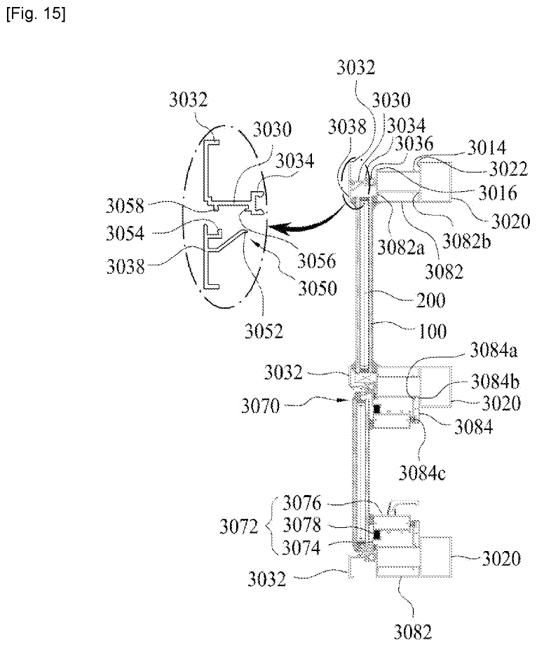

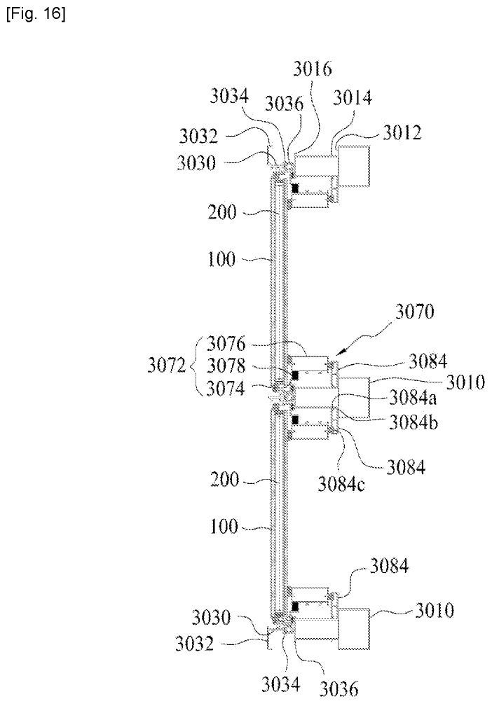

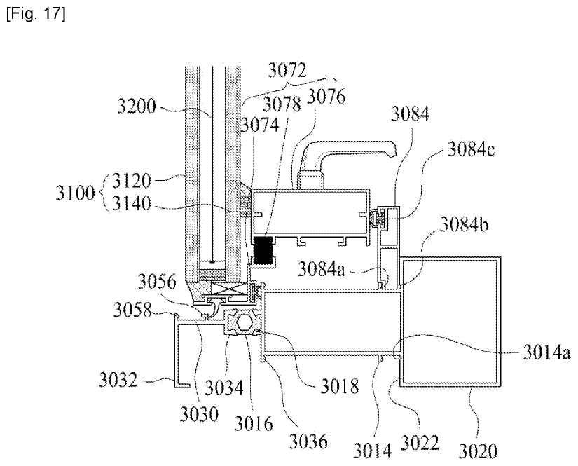

FIG. 14 is a front view of a composite system window in a double-glazed window system manufactured according to the first and second embodiments of the present invention, and FIG. 15 is a side view of a composite system window in a double-glazed window system manufactured according to the first and second embodiments of the present invention, and FIG. 16 is a top view of a composite system window in a double-glazed window system manufactured according to the first and second embodiments of the present invention, FIG. 16 is a plan view illustrating a composite system window in a double-glazed window system manufactured according to the first and second embodiments of the present invention, and FIG. 17 is a cross-sectional view illustrating a finishing block mounting structure of a composite system window in a double-glazed window system manufactured according to the first and second embodiments of the present invention.

Referring now to FIGS. 14 through 17, a window frame 3010, 3020, 3024, 3082, 3084 of a composite system window according to one embodiment of the present invention comprises a first support member 3010 installed in a first direction in an opening of a building and provided with a hollow portion, a second support member 3020 disposed spaced apart from the first support member 3010), connected to the first support member 3010), and comprising a hollow portion; and a finishing member 3024 installed in the opening of the building and closing the opening of the building, in the hole comprised by the first support member 3010 and the second support member 3020), a window 3070 that is openable and mounted in the hole section delimited by the first support member 3010 and the second support member 3020, and in which the finishing member 3024 is mounted; and a window 3070 that is mounted in the hole section formed by the first support member 3010 and the second support member 3020, a first finishing block 3082, which is pivotally coupled to the first support portion 3010 and the second support portion 3020 to support the finishing portion 3024, and a second finishing block 3084, which is pivotally coupled to the first support portion 3010 and the second support portion 3020 to support the window 3070, and which is installed in the hole formed by the first support portion 3010 and the second support portion 3020.

Here, the finish 3024 may be in the form of a glass or wood panel PANNEL).

This embodiment is a curtain wall system window, wherein a plurality of first support members 3010 and second support members 3020 are intersected by a plurality of regularly spaced and intersecting first support members 3010 and second support members 3020 to form a grid, and wherein a finishing member 3024 or window 3070 is installed in a plurality of openings to form an exterior wall of a building.

A second support member 3020 installed on an inner perimeter of an opening, and a door not shown slidably inserted into the second support member 3020 and coupled to the door, wherein the double-layered glass 10 is a component of a composite glass 10 as described above in a window system, a functional film part 200, a joining frame part 1300, a support frame part 1500, and a fixing jig part 1700, and is described as a double-layered glass 10, and may be applied to system windows, composite windows, and the like, as well as to micro-glazing windows and curtain walls.

Furthermore, in this embodiment, when installing the finishing member 3024 or window 3070 in the hole of the first support member 3010 and the second support member 3020, the back side of the finishing member 3024 is installed to be supported by the first finishing block 3082 and the back side of the window 3070 is installed to be supported by the second finishing block 3084.

The finishing block of this embodiment includes a first finishing block 3082, which is clamped to the first support member 3010 and the second support member 3020 and supports the back surface of the finishing member 3024, and a second finishing block 3084, which is clamped to the first support member 3010 and the second support member 3020 and supports the back surface of the window 3070.

Furthermore, in the first support member 3010 of this embodiment, a first step 3012 is formed on which the first closing block 3082 or the second closing block 3084 is supported, a second hook 3016 is formed at an end of the first support member 3010 to snag the first closing block 3082, and a first hook 3014 is formed at a certain distance from the first step 3012 to snag the second closing block 3084.

Further, in the second support member 3020 of this embodiment, a second step 3022 is formed on which the first closing block 3082 or the second closing block 3084 is supported, a second hook 3016 is formed at an end of the second support member 3020 to snag the first closing block 3082, and a first hook 3014 is formed at a certain distance from the second step 3022 to snag the second closing block 3084.

In addition, the first closing block 3082 has a first hanging hook 3082b that is hangingly coupled to a seating groove 3014a of the first step 3012 or the second step 3022, the first hanging hook 3082a that is snap-coupled to the second hook 3016, so that when the first closing block 3082 is installed on the first support member 3010 and the second support member 3020, the first hanging hook 3082b and the The first hanging hook 3082a can be installed on the inner wall of the first support 3010 and the second support 3020 by engaging the first hanging hook 3082b and the first hanging hook 3082a with the seating groove 3014a and the second hook 3016.

As described above, by integrally joining the first finishing block 3082 to the hole, or opening, formed by the first support member 3010 and the second support member 3020 without a separate sealing member, it is possible to prevent the sealing member from deforming or breaking due to prolonged exposure of the exterior wall of the building to sunlight or rainwater, thereby reducing the heating and cooling effectiveness of the building.

The first finishing block 3082 fits inside the first step 3012 or second step 3022 to fill the first step 3012 and second step 3022 formed in the first support member 3010 and second support member 3020, while supporting the back border of the finishing portion 3024.

In this example, the finish 3024 includes a glass member, and a separate finish may be installed that is not a glass member.

In addition, the second closing block 3084 has a second hanging hook 3084b that is snag-engaged in the hanging groove portion 3014a of the first step 3012 or the second step 3022, The second hanging hook 3084a that is snap-coupled to the first hook 3014 allows the second closing block 3084, which supports the back surface of the window 3070, to be snap-coupled to the first support 3010 or the second support 3020 so that the window 3070 can be installed in the opening of the first support 3010 and the second support 3020 without the need for a separate sealing member.

The second closing block 3084 is formed in a cuboidal shape of the same or similar size as the first closing block 3082, whereas the first closing block 3082 is installed horizontally such that it fits into the first step 3012 and the second step 3022 and fills the first step 3012 and the second step 3022, the second closing block 3084 is installed upright with one side pressed against the short sides of the first step 3012 and second step 3022 so that it protrudes inwardly into the opening.

Thus, when the window 3070 is installed in the opening formed by the lattice-like installation of the first support member 3010 and the second support member 3020, the window sill frame 3072 of the window 3070 is supported by the second closing block 3084 so that the window 3070 can be installed in the opening of the first support member 3010 and the second support member 3020 without a separate sealing member.

A second hook portion 3084a is formed at an end curved inwardly in an “N” shape to facilitate engagement with the first hook 3014, and a second hook 3084b is formed at an end of the second closing block 3084 opposite the second hook portion 3084a, and is formed to engage the seating groove 3014a and protrude outwardly from the second closing block 3084.

Therefore, when the second closing block 3084 is clamped to the first step 3012 or the second step 3022, the second closing block 3084 is inclined to clamp the second clasping hook portion 3084a to the first hook 3014, and then the first hook 3014 is rotated with the center of rotation to rotate the second closing block 3084 inwardly against the inner wall of the first step 3012 or the second step 3022. When the second closing block 3084 is rotated inwardly, the outer surface of the second closing block 3084 is disposed in close contact with the inner wall of the first step 3012 or the second step 3022, and the second hook 3084b is snap-coupled to the retention groove 3014a, thereby closely joining the second closing block 3084 to the inner wall of the first step 3012 or the second step 3022.

As noted above, since the second closing block 3084 is coupled to the first support 3010 or second support 3020 in such a way that the second closing block 3084 is tightly against the inner wall of the first step 3012 or second step 3022, no gap is formed between the second closing block 3084 and the first support 3010 or second support 3020, allowing the second closing block 3084 to be installed on the first support 3010 or second support 3020 without the need for a separate sealing member.

In addition, a sealing member is installed on the outer surface of the second closing block 3084 to closely fit the window frame 3072, and a sealing member is inserted into the sealing groove portion 3084c formed on the outer wall of the second closing block 3084 to closely fit the window frame 3072.

In addition, the first support member 3010 and the second support member 3020 of the present embodiment have a fixing groove 3018 formed in the outer wall of the first support member 3010 and the second support member 3020, and an insulating member 3036 is coupled to the fixing groove 3018, and the insulating member 3036 is coupled to the first cap member supporting the finishing member 3024, so that the first cap member can be coupled to the first support member 3010 and the second support member 3020 without a separate fastening member, The insulation member 3036 is interposed between the first cap member and the first support member 3010 and the second support member 3020 to prevent warm or cold air from the outdoors from being transferred into the room by conduction.

In addition, the first cap member includes a connecting groove 3034 that is engagingly coupled to the insulation member 3036 and an extension 3032 that is laterally curved and extends to press and hold a border of the finishing member 3024, thereby preventing the finishing member 3024 forming the exterior wall of the building from detaching in an outward direction of the building by pressing and holding the border of the finishing member 3024 with the extension 3032.

This embodiment further includes a second cap member 3038, which is snap-coupled to said first cap member by a joining portion 3050 and disposed to extend in an opposite direction from said extension 3032 to support said finishing member 3024 and another finishing member 3024 disposed adjacent thereto.

If the openings formed by the first support member 3010 and the second support member 3020 are continuous, with closures 3024 installed in each opening and disposed back-to-back, a second cap member 3038 may be installed on the other side of the extension 3032 of the first cap member to constrain other closures 3024 disposed adjacent thereto.

The cross-sectional shape of the first cap member is formed to be bent in an ‘N’ shape, and the upwardly bent portion forms an extension 3032, and a connection groove 3034 is formed at the inner end to be slidably engaged with the insulation member 3036, and a joining portion 3050 is provided on the opposite side of the extension 3032 to be engaged with the second cap member 3038.

The second cap member 3038 extends to the same or similar length as the extension 3032, has an outer end that, like the extension 3032, is curved to support the outer wall of the finishing member 3024, and has a mating portion 3050 on the other side opposite the first cap member for engagement with the first cap member.

The joining portion 3050 of this embodiment includes an elastic projection 3052 extending from the inner surface of the second cap member 3038 toward the first cap member 3030 at an inclined angle, a snagging portion 3054 extending inwardly from the top of the inner surface of the second cap member 3038 and bending toward the first cap member 3030, and a hook-shaped snagging portion 3056 opposite the elastic projection 3052, a clasping groove 3056 formed on one side of the connecting groove 3034 of the first cap member opposite the resilient protrusion 3052, and a hook-shaped clasping member formed on the first cap member in a hook shape for clasping and engaging the hook-shaped clasping member 3054.

Therefore, when joining the second cap member 3038 to the first cap member, the resilient protrusion 3052 is inserted into the jamming groove 3056 and the jamming protrusion 3054 is pressed against the jamming protrusion 3058 to deform the resilient protrusion 3052 and jam the jamming protrusion 3054 and jam the jamming protrusion 3058, The resilient force of the resilient protrusion 3052 then maintains the engagement of the snagging protrusion 3054 and the snagging protrusion 3058, thereby pressing the outer wall of the finishing member 3024 toward the interior of the building.

The construction method of the composite system window according to one embodiment of the present invention, configured as described above, is as follows.

A method of constructing a composite system window according to an embodiment, comprising: installing a plurality of first support members 3010 and second support members 3020 spaced apart from each other in an opening of a building, wherein a plurality of apertures are formed between the first support members 3010 and the second support members 3020), installing a cap member on the first support member 3010 and the second support member 3020), and seating the finishing 3024 in the holes formed by the first support member 3010 and the second support member 3020 such that an outer wall of the finishing 3024 is supported on the cap member, installing a first finishing block 3082 in the hole formed by the first support member 3010 and the second support member 3020 to secure the finishing member 3024; and inserting a window 3070 into the hole formed by the first support member 3010 and the second support member 3020 where the finishing member 3024 is not installed, a second fixing step of fixing the window 3070 by installing a second finishing block 3084 in the hole formed by the first support member 3010 and the second support member 3020 to support the window 3070.

First, a plurality of first support members 3010 and second support members 3020 are constructed and connected at regular intervals in an opening of the building to form a lattice-like support member, and a finish 3024 or window 3070 is optionally installed in the opening formed by the first support members 3010 and second support members 3020.

If the finishing member 3024 is to be installed in multiple consecutive openings, the first cap member and the second cap member 3038 are assembled and joined by the insulation member 3036 to the outer ends of the first support 3010 or second support 3020, If a window 3070 is installed adjacent to the finish 3024, only the first cap member is installed on the first support 3010 and second support 3020 so that the extension 3032 of the first cap member supports the outer wall of the finish 3024.

On the inside of the opening where the finial 3024 is installed, install the first finial block 3082 at the first step 3012 and second step 3022 to support the interior wall border of the finial 3024, and if a window 3070 is installed in the opening, install the second finial block 3084 at the first step 3012 and second step 3022 to support the window frame 3072 that frames the window 3070.

Here, the window frame 3072 comprises an outer frame 3074 disposed adjacent the outer rim of the first support member 3010 and the second support member 3020, and an inner frame 3076 inserted inwardly of the opening and disposed adjacent the second closing block 3084, a connection member 3078 that connects the outer frame 3074 to the inner frame 3076 and is made of an insulating material to prevent external warm or cold air conducted along the outer frame 3074 from being conducted onto the inner frame 3076.

This prevents warm or cold air from the exterior of the building from being conducted along the window frame 3072 into the interior.

As described above, once the opening formed by the first support member 3010 and the second support member 3020 is sealed with the finishing member 3024 or window 3070, the construction of the system window is complete.

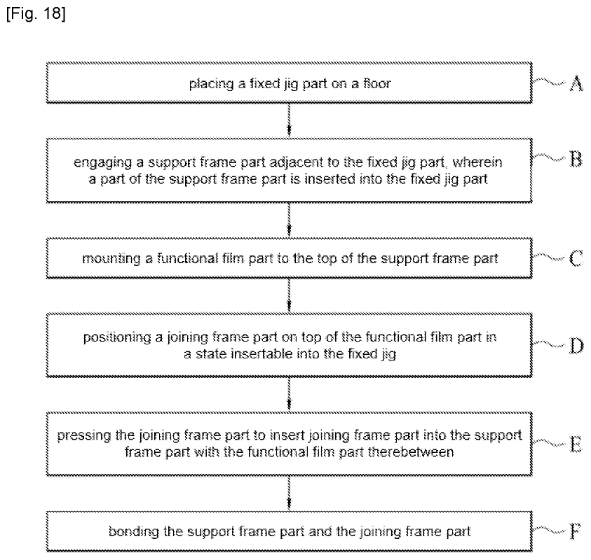

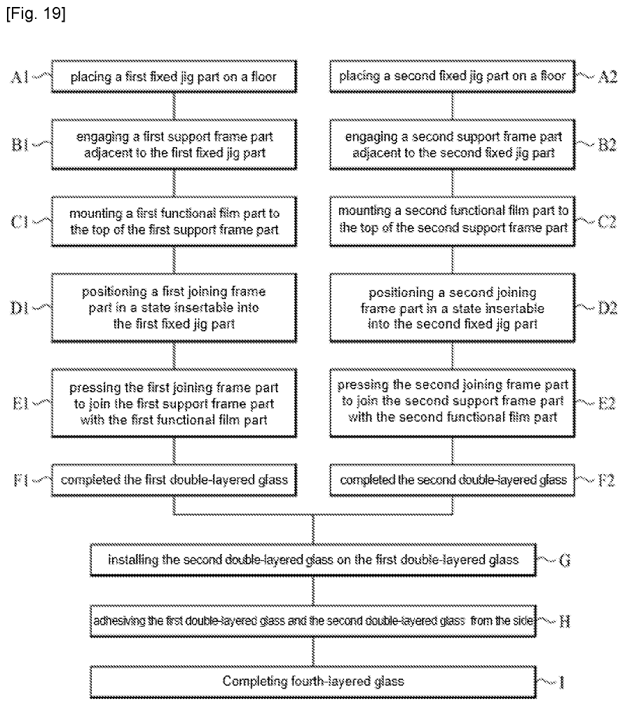

FIG. 18 is a flowchart illustrating a method of manufacturing double-layered glass according to the first and second embodiments of the present invention and a manufacturing method in a double-layered glass window system manufactured thereby, and FIG. 19 is a flowchart illustrating a method of manufacturing four-pane glass according to the first modified embodiment of the present invention and a manufacturing method in a double-layered glass window system manufactured thereby.

First, the method of manufacturing the triple-pane glass 10 according to one embodiment of the present invention, which relates to a triple-pane glass 10, may first seat the fixing jig 700 on the bottom surface (A).

The support frame part 500 can then be secured to the fixing jig portion 700 (B). At this point, the second member 548 of the fixing jig 700 can be insertably seated in the second shackle 704.

As shown above, the fixing jig portion 700 and the support frame part 500 are in contact with the bottom surface and are responsively coupled to the upward pressure, enabling support without shaking.

Next, the functional film portion 200 is positioned and seated on top of the support frame part 500 (C), where the functional film portion 200 may have a larger area than the outermost side of the support frame.

This is because the functional film portion 200 is inserted in a zigzag shape as it is inserted in the embedding region 440, so that it is formed in a predetermined large size to enlarge the contact area between the first and second protrusions and prevent it from being dislodged.

Next, the mating frame part 300 is positioned insertably into the fixing jig portion 700 and the support frame part 500 (D).

Then, when the joining frame part 300 is pressed by external pressing equipment or equipment capable of pressing with a vertically equalized force, the functional film portion 200 is fixed between the joining frame part 300 and the support frame while the tension is maintained (E).

Next, the first glass 120 and second glass 140 can be placed on the top and bottom to apply the side adhesive 800 to complete the double-layer glass 10 (F).

Next, the manufacturing method of the four-layer glass according to a modified embodiment of the present invention will be described with reference to FIG. 9.

In FIG. 19, the first double-layered glass 10 and the second double-layered glass 10 are omitted as the steps (A), (B), (C), (D), and E described in FIG. 18 are the same. However, step F of applying the adhesive 800 may be optional.

Once the first double-layered 10 and the second double-layered 10 are complete, either the first double-layered 10 or the second double-layered 10 can be flipped upside down to be seated (G).

Then, the first double-layer glass 10 and the second double-layer glass 10 can be bonded from the sides to complete the four-layer glass (I).

The above-described double-layered 10 may be applicable to sliding windows, curtain walls, and the like, including composite windows and system windows.

Preferred embodiments of the present invention have been described above, and it will be apparent to those having ordinary skill in the art that the invention may be embodied in other particular forms without departing from its spirit or scope. Accordingly, the embodiments described above should be considered exemplary rather than limiting, and the invention is not limited to the above description, but may be modified within the scope of the appended claims and equivalents thereof.

1. A double-layered glass disposed between a pair of glasses, including a first glass and a second glass, and having an expandable laminated structure with the first glass and the second glass, and facilitating insulation and UV protection, comprising:
a functional film part forming a thickness relatively smaller than that of the glasses, and having an insulating coating layer and an ultraviolet protection coating layer;
a support frame part disposed at an edge of the functional film part, and having one side of which is in contact with the second glass and the other side of which has a structure into which the functional film part is folded and inserted; and
a joining frame part having a structure capable of being snap-coupled to the support frame part with the functional film part, and having one side of which is in contact with the first glass;
wherein the support frame part and the joining frame part are formed into a structure in which the joined portions can be fitted together to prevent snap-coupled portion of the functional film part from being disjoined from the support frame part and the joining frame part.

2. The double-layered glass of claim 1, wherein the support frame part and the joining frame part comprise a support region in contact with the functional film part and a snap-coupled region extending from the support region and configured that a part protruding from the support frame part is inserted into the joining frame part when the functional film part is folded.

3. The double-layered glass of claim 2, wherein the joining frame part comprises a first projection projecting toward the support frame part and a second projection formed adjacent to said first projection toward an outer side of the double-layered glass and projecting toward the support frame part.

4. The double-layered glass of claim 3, wherein the second projection is formed relatively shorter than the first projection, and protruded toward the outer side of the double-layered glass.

5. The double-layered glass of claim 4, wherein the second projection includes a first sloping surface protruded toward the outer side of the double-layered glass from an end portion adjacent to the support frame part and formed so as to be inclined toward the first glass, and a first parallel surface bent in the direction of the first projection on the first sloping surface and parallel to the support frame part.

6. The double-layered glass of claim 4, wherein the support frame part comprises a third projection projecting between the first projection and the second projection in the snap-coupled region; and a fourth projection extending outwardly from the third projection and projecting toward the second projection parallel to the third projection,
and wherein the fourth projection formed that an end portion of fourth projection projects toward the first sloping surface of the second projection.

7. The double-layered glass of claim 6, wherein the fourth projection includes a second sloping surface in contact with the first parallel surface, and a second parallel surface formed so as to be inclined toward the first protrusion on the second parallel surface.

8. The double-layered glass of claim 1 further comprises a fixed jig part supporting the side of the support frame part and the joining frame part to prevent wobbling when the support frame part and the joining frame part are joined in a state where the functional film part is secured to the support frame part.

9. The double-layered glass of claim 8, wherein the fixed jig part comprises a first latch joined to the support frame part, and a second latch part joined to the joining frame part at a position spaced from the first latch, and wherein the area between the first latch and the second latch is formed in a bended shape corresponding to the shape of the support frame part and the joining frame part.

10. The double-layered glass of claim 1, wherein the functional film part is formed so that at least two are provided between the double-layered glass, and wherein the joining frame part comprises:
a first joining frame part; and
a second joining frame part having the same shape as the first joining frame part and disposed symmetrically about an imaginary line parallel to the first glass on an upper surface of the first joining frame part such that the upper surface is in contact with the imaginary line;
and wherein the second joining frame part is formed so as to be joined with a second support frame part.

11. A double-layered window system that has a laminated structure and contains double layers of glass for easy insulation and UV protection, comprise:
the double-layered glass of claim 1; and
a window frame formed in an opening and configured to divide the inside and outside by the double-layered glass.

12. The double-layered window system of claim 11, wherein the window frame comprises: 4
a first supporting part installed in the opening and configured to form a hollow part;
a second supporting part disposed spaced apart from the first supporting part and connected to the first supporting part and configured to form the hollow part; and
a finishing part is installed in the hollow part formed by the first supporting part and the second supporting part, and finishing the opening of a building.

13. The double-layered window system of claim 11, wherein the window frame comprises:
a first finishing block is installed in the hollow part and interlocked the first supporting part and the second supporting part to support the finishing part; and
a second finishing block is installed in the hollow part and interlocked the first supporting part and the second supporting part to support the double-layered glass.

14. A method for manufacturing double-layered glass comprises:
placing a fixed jig part on a floor;
engaging a support frame part adjacent to the fixed jig part, wherein a part of the support frame part is inserted into the fixed jig part;
mounting a functional film part to the top of the support frame part;
positioning a joining frame part on top of the functional film part in a state insertable into the fixed jig part;
pressing the joining frame part to insert the joining frame part into the support frame part with the functional film part therebetween; and
bonding the support frame part and the joining frame part.

15. The method for manufacturing double-layered glass of claim 14, wherein the bonding the support frame part and the joining frame part comprises:
a process of disposing a second glass on a lower portion of the support frame part, and disposing a first glass on an upper portion of the joining frame part;
a process of applying an adhesive to the first glass and the second glass to bond the first glass to the joining frame part and the second glass to the support frame part; and
a process of bonding the first glass, the second glass the joining frame part, the support frame part by applying an adhesive from the side.

16. The method for manufacturing double-layered glass of claim 15 further comprises removing the fixed jig while the first glass is adhered to the joining frame part and the second glass is adhered to the support frame part.
